(19) United States
(12) Patent Application Publication
(10) Pub. No.: US 2024/0073358 A1
(43) Pub. Date: Feb. 29, 2024

(54) VEHICLE MONITORING SYSTEM, VEHICLE, AND VEHICLE MONITORING METHOD

(71) Applicant: TOYOTA JIDOSHA KABUSHIKI KAISHA, Toyota-shi (JP)

(72) Inventor: Takayuki HATORI, Nagakute-shi (JP)

(73) Assignee: TOYOTA JIDOSHA KABUSHIKI KAISHA, Toyota-shi (JP)

(21) Appl. No.: 18/331,545

(22) Filed: Jun. 8, 2023

(30) Foreign Application Priority Data
Aug. 26, 2022 (JP) 2022-135123

(51) Int. Cl. H04N 5/77; B60R 16/033; G07C 5/08; H04N 7/18

(52) U.S. Cl. CPC H04N 5/77; B60R 16/033; G07C 5/0808; H04N 7/181; H04N 7/188

(57) ABSTRACT

A vehicle monitoring system includes: an acceleration sensor mounted on a vehicle and operated by a first power supply that is constantly supplied from a battery of the vehicle; and a monitoring control device that operates by the first power supply and activates one or more devices that record an image of a periphery of the vehicle when the acceleration sensor detects an acceleration of a predetermined value or more while the vehicle is parked, and causes the image to be recorded.

### CROSS-REFERENCE TO RELATED APPLICATION

This application claims priority to Japanese Patent Application No. 2022-135123 filed on Aug. 26, 2022, incorporated herein by reference in its entirety.

### BACKGROUND

### 1. Technical Field

The present disclosure relates to a vehicle monitoring system, a vehicle, and a vehicle monitoring method.

### 2. Description of Related Art

A vehicle monitoring system that records an image of surroundings of a vehicle captured by a camera in response to an impact while the vehicle is parked is known (see, for example, Japanese Unexamined Patent Application Publication No. 2020-136790 (JP 2020-136790 A).

### SUMMARY

There is a demand for realizing a vehicle monitoring system that records an image of surroundings of a vehicle captured by a camera in response to an impact while the vehicle is parked using an acceleration sensor provided in the vehicle.

However, when a device that detects the impact is constantly activated while the vehicle is parked, power consumption of a battery of the vehicle during parking may increase.

An embodiment of the present disclosure has been made in view of the above issue, and realizes a vehicle monitoring system using an acceleration sensor provided in a vehicle while power consumption of a battery of the vehicle during parking is suppressed.

In order to solve the above issue, a vehicle monitoring system according to an embodiment of the present disclosure includes: an acceleration sensor mounted on a vehicle and operated with a first power supply constantly supplied from a battery of the vehicle; and a monitoring control device that operates with the first power supply, activates one or more devices that record an image of surroundings of the vehicle when the acceleration sensor detects an acceleration equal to or greater than a predetermined value while the vehicle is parked, and causes the one or more devices to record the image.

According to the embodiment of the present disclosure, the vehicle monitoring system can be realized using the acceleration sensor provided in the vehicle while power consumption of the battery of the vehicle during parking is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a system configuration of a vehicle monitoring system according to a first embodiment;

FIG. 2 is a diagram illustrating another example of the system configuration of the vehicle monitoring system according to the first embodiment;

FIG. 3 is a diagram illustrating an example of a hardware configuration of a computer according to an embodiment;

FIG. 4 is a flowchart (1) illustrating an example of a setting process of the acceleration sensor according to the first embodiment;

FIG. 5 is a flowchart (2) illustrating an example of a setting process of the acceleration sensor according to the first embodiment;

FIG. 6 is a flowchart illustrating an example of parking processing according to an embodiment;

FIG. 7 is a diagram illustrating an example of a system configuration of a vehicle monitoring system according to the second embodiment.

### DETAILED DESCRIPTION OF EMBODIMENTS

Hereinafter, the present embodiment (embodiment of the present disclosure) will be described with reference to the drawings. Note that, in the present specification and the drawings, constituent elements having substantially the same functional configuration are denoted by the same reference numerals, and redundant description thereof will be omitted.

### First Embodiment

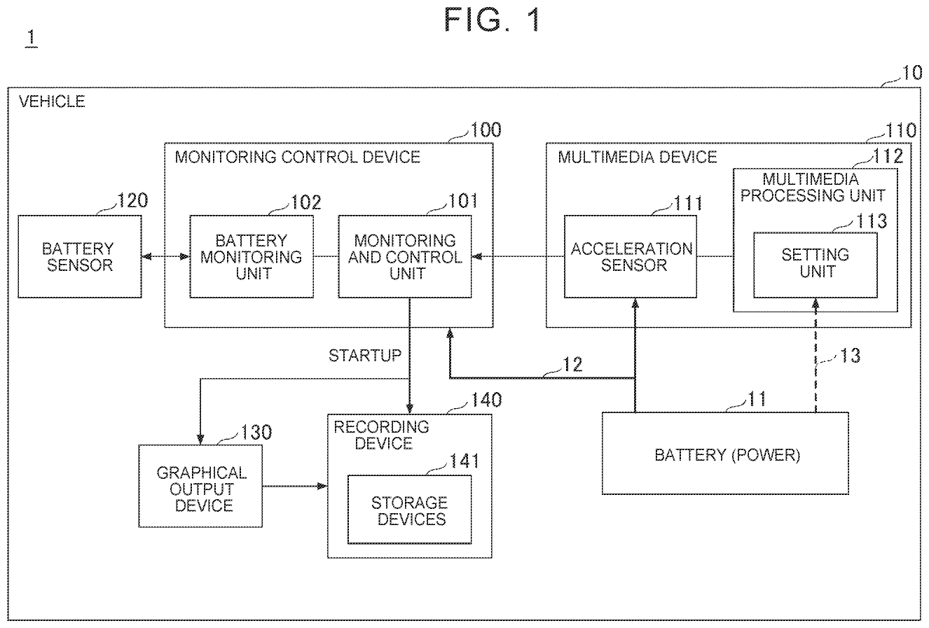

FIG. 1 is a diagram illustrating an example of a system configuration of a vehicle monitoring system according to a first embodiment. The vehicle monitoring system 1 is mounted on a vehicle 10 such as an automobile, and is a system that records a video captured by a camera around the vehicle in response to an impact during parking. In the example of FIG. 1, the vehicle monitoring system 1 includes a multimedia device 110, a monitoring control device 100, a battery sensor 120, an image output device 130, a recording device 140, and the like.

The multimedia device 110 is, for example, a navigation Electronic Control Unit (ECU having a car navigation function, or an electronic control device (first electronic control device) such as a multimedia ECU. The multimedia device 110 according to the present embodiment includes an acceleration sensor 111 and a multimedia processing unit 112.

The acceleration sensor 111 is a sensor that operates with a constant supply power supply (hereinafter referred to as a first power supply 12) that is constantly supplied from the battery 11 of the vehicle 10, and measures acceleration. The acceleration sensor 111 may be included in, for example, an acceleration sensor, an Inertial Measurement Unit (IMU) including an angular velocity (gyro) sensor, or the like.

The multimedia processing unit 112 provides a navigation function using the acceleration sensor 111 when a second power supply 13 (such as an accessory power source of the vehicle 10) different from the first power supply is supplied.

Further, the multimedia processing unit 112 includes a setting unit 113 that changes the setting of the acceleration sensor 111 to a setting for parking when the vehicle is parked. For example, the setting unit 113 sets the acceleration sensor 111 necessary for detecting an impact of the vehicle 10. When the acceleration sensor 111 is included in the inertial measurement device or the like, the setting unit 113 may stop the operation of the angular velocity sensor among the acceleration sensor 111 and the angular velocity sensor included in the inertial measurement device.

The monitoring control device 100 is an electronic control device that operates with a first power supply that is constantly supplied from the battery 11 of the vehicle 10. Preferably, the monitoring control device 100 is realized by a small-scale microcomputer with low power consumption, a storage medium storing a program for the monitoring control device 100, and the like. In the example of FIG. 1, the monitoring control device 100 realizes the monitoring control unit 101, the battery monitoring unit 102, and the like by the microcomputer included in the monitoring control device 100 executing a predetermined program.

The monitoring control unit 101 operates with the first power supply, and activates the image output device 130 and the recording device 140 when the acceleration sensor 111 detects an acceleration of a predetermined value or more while the vehicle 10 is parked. As a result, the image output device 130 and the recording device 140 record an image of the surroundings of the vehicle 10.

The battery monitoring unit 102 estimates the remaining amount of the battery 11 based on the state of the battery 11 detected by the battery sensor 120. For example, the battery sensor 120 transmits information of the battery 11 such as a charging current, a discharging current, a voltage, or a temperature of the battery 11 to the battery monitoring unit 102 as a state of the battery 11. Further, the battery monitoring unit 102 calculates the remaining amount (available battery capacity) of the battery 11 based on the state of the battery 11 received from the battery sensor 120.

For example, when the acceleration sensor 111 detects an impact of a predetermined value or more while the vehicle 10 is parked, the battery monitoring unit 102 calculates the remaining amount of the current battery 11 by any of the following methods, for example.

### Method 1

During parking of the vehicle 10, the battery sensor 120 is stopped, and the battery monitoring unit 102 acquires the state of the battery 11 from the battery sensor 120 when the vehicle 10 starts parking. In addition, when the acceleration sensor 111 detects an acceleration of a predetermined value or more during parking, the battery monitoring unit 102 calculates the current remaining battery capacity of the battery 11 based on the remaining battery capacity at the time of starting parking, the elapsed time from the start of parking, the power consumption at the time of parking, and the like.

### Method 2

During parking of the vehicle 10, the battery sensor 120 is stopped, and the battery monitoring unit 102 activates the battery sensor 120 to acquire the state of the battery 11 when the acceleration sensor 111 detects an acceleration of a predetermined value or more during parking. Further, the battery monitoring unit 102 calculates the current remaining battery capacity of the battery 11 based on the acquired state of the battery 11.

### Method 3

The battery sensor 120 is constantly activated while the vehicle 10 is parked by using the battery sensor 120 that consumes less power. The battery monitoring unit 102 acquires the state of the battery 11 from the battery sensor 120 when the acceleration sensor 111 detects an acceleration of a predetermined value or more during parking, and calculates the remaining battery capacity of the current battery 11 based on the acquired state of the battery 11. Note that the battery monitoring unit 102 may acquire the remaining battery capacity of the current battery 11 by a method other than the methods 1 to 3.

The image output device 130 is a device that outputs a video of the periphery of the vehicle 10. As an example, the image output device 130 is an electronic control device such as a Panoramic View Monitor (PVM) or an Electronic Control Unit (ECU) that generates a video around the vehicle 10 using a front image, a rear image, a right side image, a left side image, and the like captured by a plurality of cameras. Note that the image output device 130 is an example of a third electronic control device. As another example, the image output device 130 may be one or more cameras or the like that photograph the periphery of the vehicle 10.

The recording device 140 is an electronic control unit (fourth electronic control unit) that records, in the storage device 141 or the like, an image of the periphery of the vehicle 10 output by the image output device 130.

The image output device 130 and the recording device 140 stop the operation while the vehicle 10 is parked, and start up in response to an activation signal or the like from the monitoring control device 100. The activated image output device 130 and the recording device 140 stop the operation again after recording the video around the vehicle for a predetermined period of time.

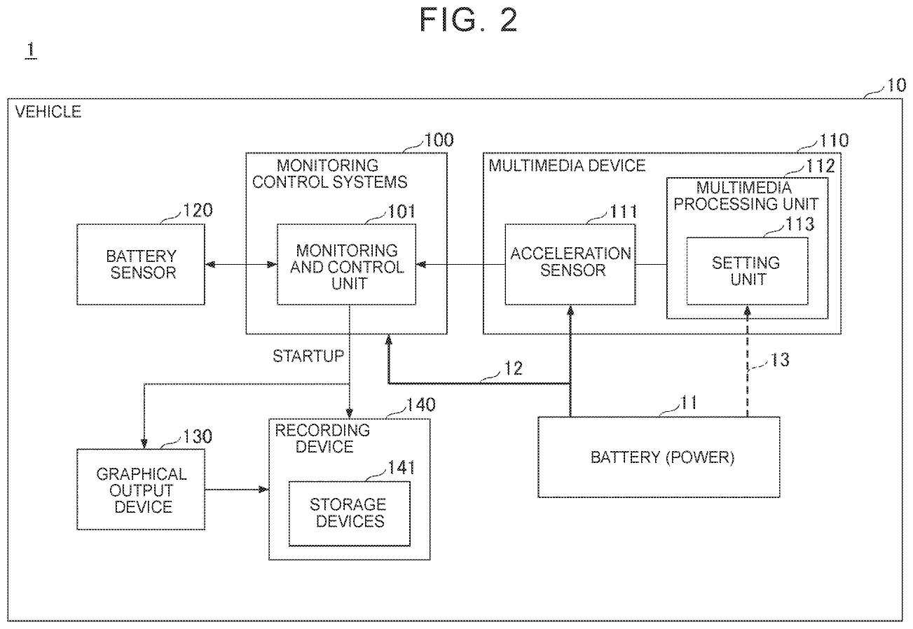

The system configuration of the vehicle monitoring system 1 shown in FIG. 1 is an example. For example, as illustrated in FIG. 2, the monitoring control device 100 may not include the battery monitoring unit 102 and acquire the current battery capacity of the battery 11 from the battery sensor 120. The recording device 140 may be included in the image output device 130. In addition, the recording device 140 may be included in the multimedia device 110, the monitoring control device 100, or the like.

### Hardware Configuration

### Hardware Configuration of the Monitoring Control Device

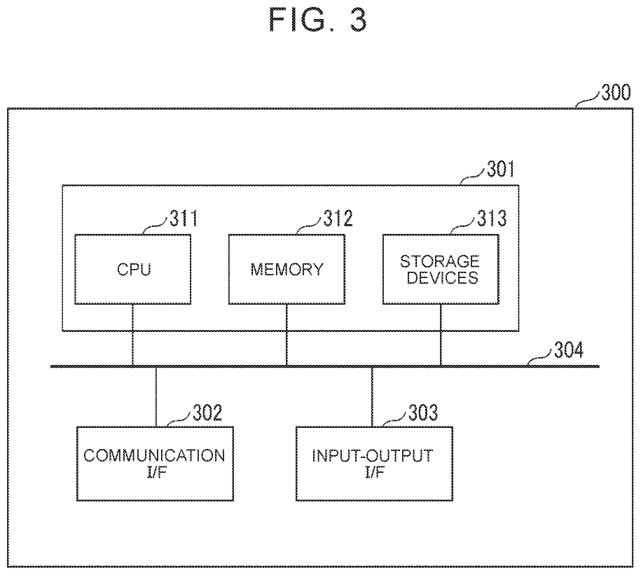

The monitoring control device 100 includes, for example, a hardware configuration of a computer as illustrated in FIG. 3.

FIG. 3 is a diagram illustrating an example of a hardware configuration of a computer according to an embodiment. In the illustration of FIG. 3, computer 300 includes Central Processing Unit (CPU) 311, memories 312, storage devices 313, communication Interface (I/F) 302, input/output I/F 303, and busses 304, etc.

CPU 311 is, for example, a processor that executes various processes by executing predetermined programs stored in a storage medium such as the memory 312 or the storage device 313. The memory 312 includes, for example, Random Access Memory (RAM which is a volatile memory used as a work area of a CPU 311 and the like, and a Read Only Memory (ROM in which programs for starting a CPU 311 and the like are stored in advance. The storage device 313 is, for example, a large-capacity nonvolatile storage device such as a flash ROM. Note that CPU 311, the memory 312, the storage device 313, and the like may be realized by one device such as the microcomputer 301.

The communication OF 302 includes, for example, a network interface for connecting the computer 300 to an in-vehicle network of the vehicle 10 and communicating with other electronic control units (ECU). The input/output I/F 303 are interfaces for connecting external devices to the computer 300. For example, the acceleration sensor 111, the battery sensor 120, and the like are connected to the input/output I/F 303 of the computer 300 included in the monitoring control device 100. The bus 304 is connected to each of the above-described components, and transmits, for example, an address signal, a data signal, various control signals, and the like.

### Hardware Configuration of the Multimedia Device

The multimedia device 110 includes, for example, an acceleration sensor 111 that operates with a first power supply that is constantly supplied from the battery 11, and a computer 300 as illustrated in FIG. 3.

The computer 300 included in the multimedia device 110 operates when the second power supply 13, which differs from the first power supply, is supplied, and for example, the acceleration sensor 111 is connected to the input/output I/F 303. The computer 300 included in the multimedia device 110 implements the multimedia processing unit 112, the setting unit 113, and the like described with reference to FIG. 1 by executing a program stored in a storage medium such as the storage device 313 or the memory 312.

### Hardware Configuration of the Image Output Device

The image output device 130 has, for example, a hardware configuration of the computer 300 as shown in FIG. 3, and one or more cameras for capturing the surroundings of the vehicles 10 are connected to the input/output I/F 303. The image output device 130 is connected to the first power supply 12 that is constantly supplied from the battery 11, and has a power switch that supplies power to the computer 300 included in the image output device 130 in response to an activation signal or the like from the monitoring control device 100.

### Hardware Configuration of the Recorder

As an example, the recording device 140 has a hardware configuration of the computer 300 including the storage device 141. In this case, the storage device 141 and the storage device 313 may be the same device. As another example, the recording device 140 may be an external storage device or the like including the storage device 141. The recording device 140 is connected to the first power supply 12 that is constantly supplied from the battery 11, and has a power switch that supplies power to the computer 300 or the like included in the recording device 140 in response to an activation signal or the like from the monitoring control device 100.

### Battery and Battery Sensor

The battery 11 is a battery included in the vehicle 10. The battery sensor 120 is attached to the battery 11 so as to be able to detect the state of the battery 11, for example.

### Process Flow

Next, a flow of processing of the vehicle monitoring method according to the first embodiment will be described.

### Acceleration Sensor Setting Process 1

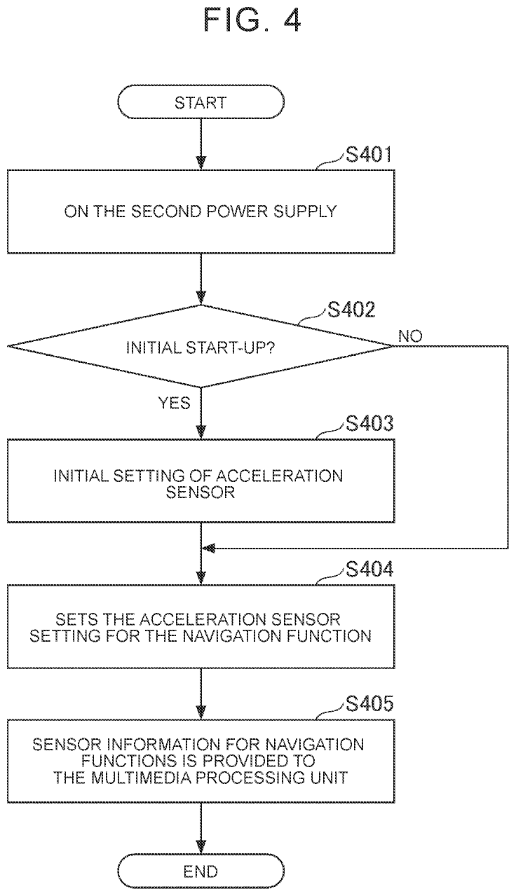

FIG. 4 is a flowchart (1) illustrating an example of a setting process of the acceleration sensor according to the first embodiment. This processing is an exemplary setting processing of the acceleration sensor executed by the vehicle monitoring system 1 when the second power supply 13 (for example, the accessory power supply) of the vehicle is turned ON.

In S401, when the second power supply 13 of the vehicle 10 is turned ON, the vehicle monitoring system 1 executes the processes after S402.

In S402, when the multimedia processing unit 112 is activated by the second power supply 13, the setting unit 113 determines whether the activation is the first activation. For example, the setting unit 113 determines that the activation is the first time when the initial setting is not performed for the acceleration sensor 111 in the multimedia device 110. When the start is the first time, the setting unit 113 shifts the process to S403. On the other hand, if it is not the first activation, the setting unit 113 shifts the process to S404.

In S403, the setting unit 113 performs initial setting on the acceleration sensor 111. For example, the setting unit 113 writes the setting for the navigation function and the setting for the parking time to the acceleration sensor 111.

When shifting to S404, the setting unit 113 sets the setting of the acceleration sensor 111 for the navigational function.

In S405, the acceleration sensor 111 starts providing sensor data for the navigation function to the multimedia processing unit 112. As a result, the multimedia processing unit 112 can use the sensor information provided from the acceleration sensor 111 for positioning the vehicle 10.

### Acceleration Sensor Setting Process 2

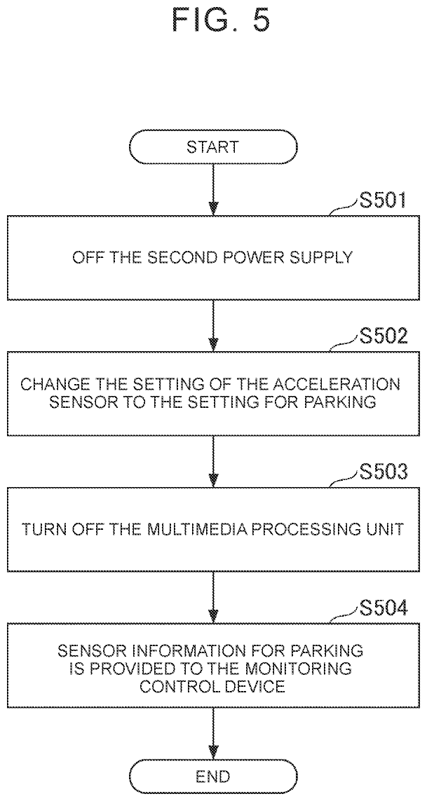

FIG. 5 is a flowchart (2) illustrating an example of a setting process of the acceleration sensor according to the first embodiment. This processing is an exemplary setting processing of the acceleration sensor executed by the vehicle monitoring system 1 when the second power supply 13 (for example, the accessory power supply) of the vehicle is turned OFF.

In S501, when the second power supply 13 of the vehicle 10 is turned OFF, the vehicle monitoring system 1 executes the processes after S502.

In S502, the setting unit 113 switches the setting of the acceleration sensor 111 to the setting for parking.

In S503, the multimedia device 110 turns OFF the power of the multimedia processing unit 112.

In S504, the acceleration sensor 111 starts providing sensor data for parking to the monitoring control device 100.

By the processes of FIGS. 4 and 5, the vehicle monitoring system 1 according to the first embodiment can detect the impact of the vehicle 10 at the time of parking by using the acceleration sensor 111 included in the multimedia device 110.

### Processing at the Time of Parking

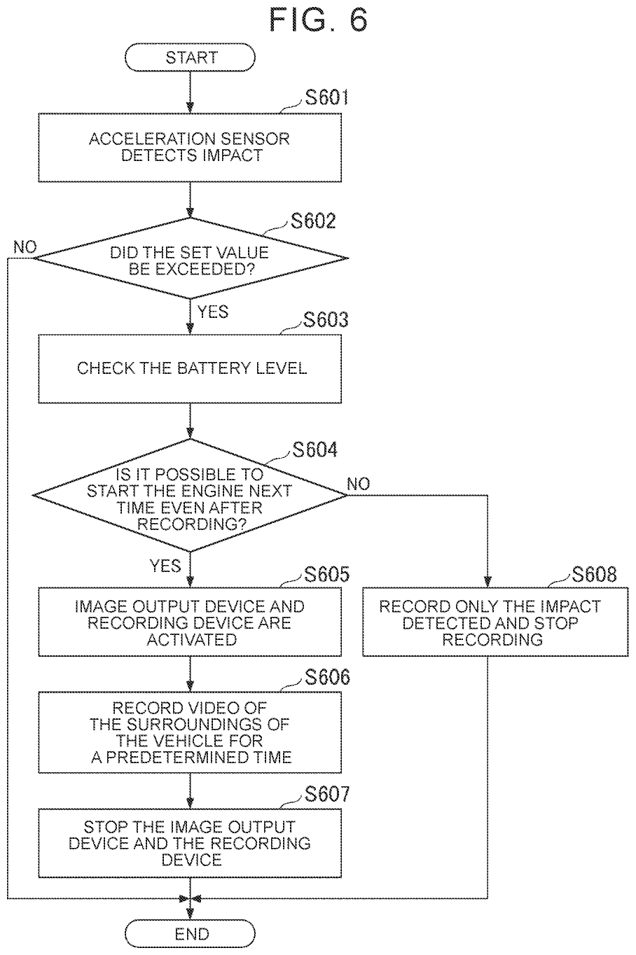

FIG. 6 is a flowchart illustrating an example of parking processing according to an embodiment. This processing shows an example of processing executed by the vehicle monitoring system 1 when the vehicle 10 is parked. It is assumed that the vehicle monitoring system 1 has already executed the acceleration sensor setting processing described with reference to FIG. 5 at the start of the processing illustrated in FIG. 6.

In S601, when the acceleration sensor 111 detects an impact during parking of the vehicle 10, the vehicle monitoring system 1 executes S602 and subsequent processes.

In S602, the monitoring control unit 101 of the monitoring control device 100 determines whether or not the detected acceleration exceeds a set value (a predetermined value or more). Here, it is assumed that a value for determining whether or not the vehicle monitoring system 1 records an image of the surroundings of the vehicle 10 is set in advance in the monitoring control unit 101.

When the detected acceleration exceeds the set value, the monitoring control unit 101 shifts the process to S603. On the other hand, when the detected acceleration does not exceed the set value, the monitoring control unit 101 stops executing the processing after S603, and ends the processing in FIG. 6.

In S603, the monitoring control device 100 checks the remaining battery capacity of the battery 11 of the vehicle 10. For example, when the detected acceleration exceeds the set value, the monitoring control unit 101 of the monitoring control device 100 inquires of the battery monitoring unit 102 about the remaining battery level. In response to this, the battery monitoring unit 102 calculates the current remaining battery capacity of the battery 11 by any of the above-described methods 1 to 3, and notifies the monitoring control unit 101 of the calculated remaining battery capacity.

As another example, when the detected acceleration exceeds the set value, the battery monitoring unit 102 of the monitoring control device 100 may calculate the current remaining battery capacity of the battery 11 and notify the monitoring control unit 101 of the calculated remaining battery capacity.

In S604, the monitoring control unit 101 of the monitoring control device 100 determines whether or not the next start of the engine can be performed even if recording is performed with the present remaining battery capacity. For example, the monitoring control unit 101 stores in advance the remaining battery capacity capable of sufficiently starting the engine of the vehicle 10 and the battery capacity consumed in one recording. In addition, when the value obtained by subtracting the battery capacity consumed in one recording from the current remaining battery capacity is equal to or more than the remaining battery capacity that can sufficiently start the engine of the vehicle 10, the monitoring control unit 101 determines that the next engine start is possible even if the recording is performed.

If the next start of the engine is allowed even after the recording, the monitoring control unit 101 shifts the process to S605. On the other hand, when recording is performed, the monitoring control unit 101 shifts the process to S608 when the next start-up cannot be performed.

In S605, the monitoring control unit 101 of the monitoring control device 100 activates the image output device 130 and the recording device 140. For example, the monitoring control unit 101 outputs an activation signal to the image output device and the recording device 140.

In S606, the image output device 130 and the recording device 140 record a video of the surroundings of the vehicles 10 for a predetermined period of time. For example, the recording device 140 stores video data of the surroundings of the vehicle 10 output by the image output device 130 with a time stamp or the like attached to the storage device 141.

In S607, the vehicle monitoring system 1 stops the image output device 130 and the recording device 140 after the recording is completed. For example, the monitoring control unit 101 of the monitoring control device 100 may set (negate) the activation signal that is set (asserted) to be valid in S605 to be invalid, and stop the image output device 130 and the recording device 140. Alternatively, the image output device 130 and the recording device 140 may autonomously stop the operation after the recording is finished.

On the other hand, when shifting from S604 to S608, the monitoring control unit 101 of the monitoring control device 100 records only the detection of the impact and stops the recording. For example, the monitoring control unit 101 ends the process of FIG. 6 without executing the process of S607 from S605. By this processing, the vehicle monitoring system 1 can suppress the battery rise during parking.

Preferably, the monitoring control unit 101 stores data indicating that an impact has been detected, and causes the recording device 140 to store the stored data the next time the recording device 140 is activated.

According to the processes of FIGS. 4 to 6, according to the first embodiment, the vehicle monitoring system can be realized by using the acceleration sensor 111 included in the multimedia device 110 while suppressing the power consumption of the battery 11 of the vehicle 10 during parking.

### Second Embodiment

In the first embodiment, an example in which the vehicle monitoring system 1 is realized using the acceleration sensor 111 for the navigation function (for positioning) included in the multimedia device 110 has been described. However, this is an example, and the vehicle monitoring system 1 according to the present embodiment may use another acceleration sensor included in the vehicle 10.

For example, when the vehicle 10 includes an intrusion detection system that detects an intrusion into the vehicle 10, the vehicle monitoring system 1 may be realized by using an acceleration sensor for the intrusion detection system.

### System Configuration

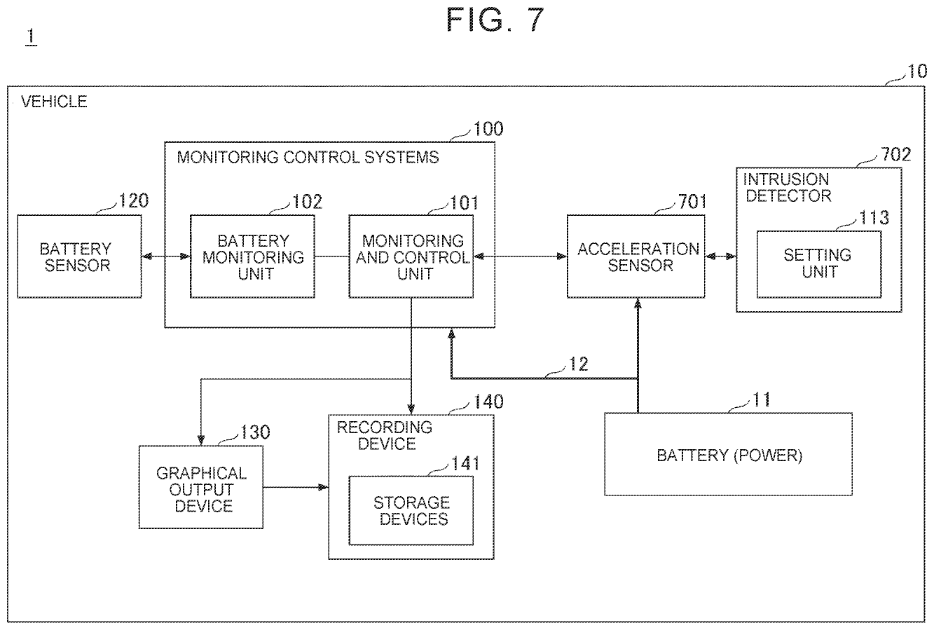

FIG. 7 is a diagram illustrating an example of a system configuration of the vehicle monitoring system 1 according to the second embodiment. In the example of FIG. 7, the vehicle monitoring system 1 includes an intrusion detection device 702 and an acceleration sensor 701 for an intrusion detection system. The configuration of the monitoring control device 100, the battery sensor 120, the image output device 130, the recording device 140, the battery 11, and the like included in the vehicle monitoring system 1 according to the second embodiment may be the same as the configuration of the vehicle monitoring system 1 according to the first embodiment.

The intrusion detection device 702 is, for example, an electronic control device (second electronic control device) such as a body ECU that provides an intrusion detection function of warning by sound and light when an unauthorized intrusion into the vehicle 10 is detected using the acceleration sensor 111, the ultrasonic sensor, or the like.

The acceleration sensor 701 for an intrusion detection system is basically configured to detect an acceleration of the vehicle 10 in order to detect an intruder even during parking of the vehicle 10. Therefore, the vehicle monitoring system 1 according to the second embodiment does not need to include the setting unit 113 that performs the setting processing of the acceleration sensor described with reference to FIGS. 4 and 5, for example. However, the present disclosure is not limited thereto, and the intrusion detection device 702 may include the setting unit 113 that changes the setting of the acceleration sensor 701 when the vehicle 10 is parked as necessary.

The acceleration sensor 701 is, for example, an acceleration sensor mounted in advance in the vehicle 10 for an intrusion detection system. The acceleration sensor 701 is connected to, for example, the first power supply 12 constantly supplied from the battery 11 so as to be able to detect an impact of the vehicle 10 even when the vehicle 10 is parked. In addition, the acceleration sensor 701 according to the present embodiment is configured to output sensor information indicating the detected acceleration to the monitoring control device 100 in addition to the intrusion detection device 702.

The system configuration of the vehicle monitoring system 1 shown in FIG. 7 is an example. For example, the monitoring control device 100 according to the second embodiment may not include the battery monitoring unit 102 and acquire the current battery capacity of the battery 11 from the battery sensor 120, as in the first embodiment. The recording device 140 may be included in the image output device 130. In addition, the recording device 140 may be included in the multimedia device 110, the monitoring control device 100, or the like.

### Process Flow

In the vehicle monitoring system 1 according to the second embodiment, when the vehicle 10 is parked, the processing at the time of parking described with reference to FIG. 6 is executed using the acceleration sensor 701 described with reference to FIG. 7 instead of the acceleration sensor 111. For example, in the vehicle monitoring system 1 according to the second embodiment, when the acceleration sensor 701 detects an impact during parking of the vehicle 10 in S601, the vehicle monitoring system 1 executes a process of S608 from S602. S602 to S608 process may be the same as that of the first embodiment.

As described above, the vehicle monitoring system 1 according to the present disclosure may detect an impact (acceleration) during parking of the vehicle 10 by using various acceleration sensors included in the vehicle 10.

As described above, according to the embodiments of the present disclosure, it is possible to realize the vehicle monitoring system 1 by using the acceleration sensor included in the vehicle while suppressing the power consumption of the battery of the vehicle during parking. Further, according to the embodiments of the present disclosure, it is possible to eliminate the dedicated acceleration sensor of the vehicle monitoring system 1.

Although the embodiments of the present disclosure have been described above, the present disclosure is not limited to these embodiments, and various modifications, changes, or applications are possible within the scope of the gist of the present disclosure described in the claims.

What is claimed is:

1. A vehicle monitoring system comprising:
an acceleration sensor mounted on a vehicle and operated with a first power supply constantly supplied from a battery of the vehicle; and
a monitoring control device that operates with the first power supply, activates one or more devices that record an image of surroundings of the vehicle when the acceleration sensor detects an acceleration equal to or greater than a predetermined value while the vehicle is parked, and causes the one or more devices to record the image.

2. The vehicle monitoring system according to claim 1, further comprising a first electronic control device, wherein:
the first electronic control device includes the acceleration sensor; and
when a second power supply different from the first power supply is supplied, a navigation function is provided using the acceleration sensor.

3. The vehicle monitoring system according to claim 2, further comprising a setting unit configured to change a setting of the acceleration sensor when the vehicle is parked.

4. The vehicle monitoring system according to claim 1, further comprising a second electronic control device that provides an intrusion detection function that detects an intruder into the vehicle using the acceleration sensor while the vehicle is parked.

5. The vehicle monitoring system according to claim 1, wherein the monitoring control device
determines whether next start-up of an engine of the vehicle is possible even through the image is recorded when the acceleration sensor detects the acceleration equal to or greater than the predetermined value while the vehicle is parked, and
suspends recording of the image or activation of the one or more devices when the next start-up of the engine is not possible.

6. The vehicle monitoring system according to claim 5, further comprising a battery monitoring unit configured to monitor a remaining level of the battery of the vehicle, wherein the monitoring control device determines, based on the remaining level of the battery, whether the next start-up of the engine is possible even through the image is recorded.

7. The vehicle monitoring system according to claim 1, wherein the one or more devices include a third electronic control device that generates an image of the surroundings of the vehicle using an image of the surroundings of the vehicle captured by one or more cameras or images of the surroundings of the vehicle captured by a plurality of cameras.

8. The vehicle monitoring system according to claim 1, wherein the one or more devices include a fourth electronic control device that records an image output from an image output device that outputs the image of the surroundings of the vehicle.

9. A vehicle comprising the vehicle monitoring system according to claim 1.

10. A vehicle monitoring method comprising:
supplying a power supply constantly supped from a battery of a vehicle to an acceleration sensor and a monitoring control device mounted on the vehicle; and
activating one or more devices that record an image of surroundings of the vehicle when the acceleration sensor detects an acceleration equal to or greater than a predetermined value while the vehicle is parked, and causing the one or more devices to record the image, by the monitoring control device.
